(19) United States
(12) Patent Application Publication
(10) Pub. No.: US 2018/0359944 A1
(43) Pub. Date: Dec. 20, 2018

(54) SYSTEMS AND METHODS FOR UTILIZING LED RECIPES FOR A GROW POD

(71) Applicant: Grow Solutions Tech LLC, Lehi, UT (US)

(72) Inventors: Gary Bret Millar, Highland, UT (US); Mark Gerald Stott, Eagle Mountain, UT (US); Todd Garrett Tueller, American Fork, UT (US)

(73) Assignee: Grow Solutions Tech LLC, Lehi, UT (US)

(21) Appl. No.: 15/949,432

(22) Filed: Apr. 10, 2018

Related U.S. Application Data
(60) Provisional application No. 62/519,607, filed on Jun. 14, 2017.
(60) Provisional application No. 62/519,326, filed on Jun. 14, 2017.
(60) Provisional application No. 62/519,304, filed on Jun. 14, 2017.

(51) Int. Cl. A01G 9/20; H05B 33/08

(52) U.S. Cl. CPC A01G 9/20; H05B 33/0872

(57) ABSTRACT

A light control system includes a lighting device, a cart configured to move along a track under the lighting device, and a controller. The controller includes a processor a memory module storing lighting recipes, and machine readable instructions stored in the memory module that, when executed by the processors, causes the controller to identify a plant in the one or more carts, retrieve a lighting recipe for the identified plant from the one or more memory modules, and control operations of the one or more lighting devices based on the lighting recipe for the identified plant.

### CROSS REFERENCE TO RELATED APPLICATIONS

This application claims the benefit of U.S. Provisional Patent Application Nos. 62/519,607, 62/519,326, and 62/519,304 all filed on Jun. 14, 2017, the entire contents of which are herein incorporated by reference.

### TECHNICAL FIELD

Embodiments described herein generally relate to systems and methods for utilizing LED recipes for a grow pod and, more specifically, to controlling LED lights for illuminating plants in the assembly line grow pod based on the recipes.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the some countries currently have suitable farmland to adequately provide food for their population, other countries and future populations may not have enough farmland to provide the appropriate amount of food. Artificial lights may be used to grow crops indoor. However, heat from artificial lights may affect the crops, and the artificial lights may not be properly controlled to provide lights of adequate wavelength to the crops.

### SUMMARY

In one embodiment, a light control system includes one or more lighting devices, one or more carts configured to move along a track under the one or more lighting devices, and a controller. The controller includes one or more processors, one or more memory modules storing lighting recipes, and machine readable instructions stored in the one or more memory modules that, when executed by the one or more processors, cause the controller to: identify a plant in the one or more carts, retrieve a lighting recipe for the identified plant from the one or more memory modules, and control operations of the one or more lighting devices based on the lighting recipe for the identified plant.

In another embodiment, a method for controlling light for plants includes sending instructions to one or more carts to move along a track under one or more lighting devices; identifying a plant in the one or more carts; retrieving a lighting recipe for the identified plant from one or more memory modules; and controlling operations of the one or more lighting devices based on the lighting recipe for the identified plant.

In another embodiment, a controller for one or more lighting devices includes one or more processors; one or more memory modules storing lighting recipes; and machine readable instructions stored in the one or more memory modules. The machine readable instructions, when executed by the one or more processors, cause the controller to: send instructions to the one or more carts to move along a track under the one or more lighting devices; identify a plant in the one or more carts moving under the one or more lighting devices; retrieve a lighting recipe for the identified plant from the one or more memory modules; and send one or more instructions for controlling operations of the one or more lighting devices based on the lighting recipe for the identified plant.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an assembly line grow pod, according to embodiments described herein;

FIG. 2 depicts a partial view of the assembly line grow pod in FIG. 1, according to embodiments described herein;

FIG. 3A depicts an industrial cart for coupling to a track, according to embodiments described herein;

FIG. 3B depicts a plurality of industrial carts in an assembly line configuration, according to embodiments described herein;

FIG. 4 depicts a lighting device, according to embodiments described herein;

FIG. 5A depicts grow lighting devices illuminating carts moving along the track of the assembly line grow pod, according to embodiments described herein;

FIG. 5B depicts grow lighting devices illuminating carts moving along the track of the assembly line grow pod, according to embodiments described herein;

FIG. 6 depicts a flowchart for operating grow lighting devices based on LED recipes, according to embodiments described herein;

FIG. 7 depicts a computing environment for an assembly line grow pod, according to embodiments described herein; and

FIG. 8 depicts a computing device for an assembly line grow pod, according to embodiments described herein.

### DETAILED DESCRIPTION

Embodiments disclosed herein include systems and methods for utilizing LED recipes for a grow pod. Some embodiments are configured with an assembly line of plants that follow a track that wraps around a first axis in a vertically upward direction and wraps around a second axis in vertically downward direction. These embodiments may utilize lighting devices (e.g. LED devices) for simulating a plurality of different light wavelengths for the plants to grow increase output, and/or react otherwise as desired. A master controller may control the operations of the lighting devices based on lighting recipes for the plants. The master controller identifies a plant in the one or more carts, retrieves a lighting recipe for the identified plant from one or more memory modules, and controls operations of the one or more lighting devices based on the lighting recipe for the identified plant. The systems and methods for utilizing LED recipes for a grow pod incorporating the same will be described in more detail, below.

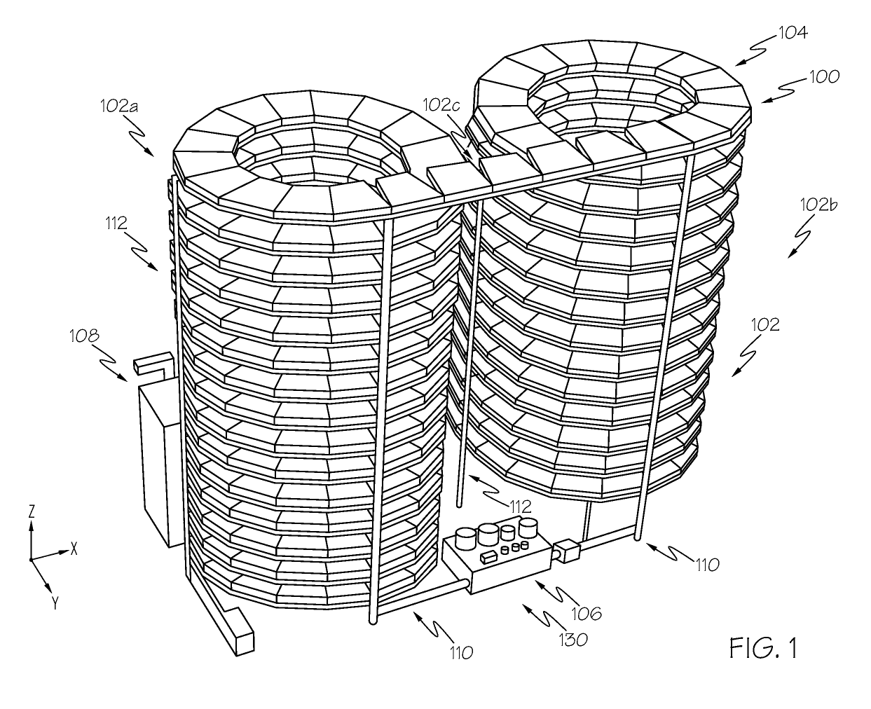

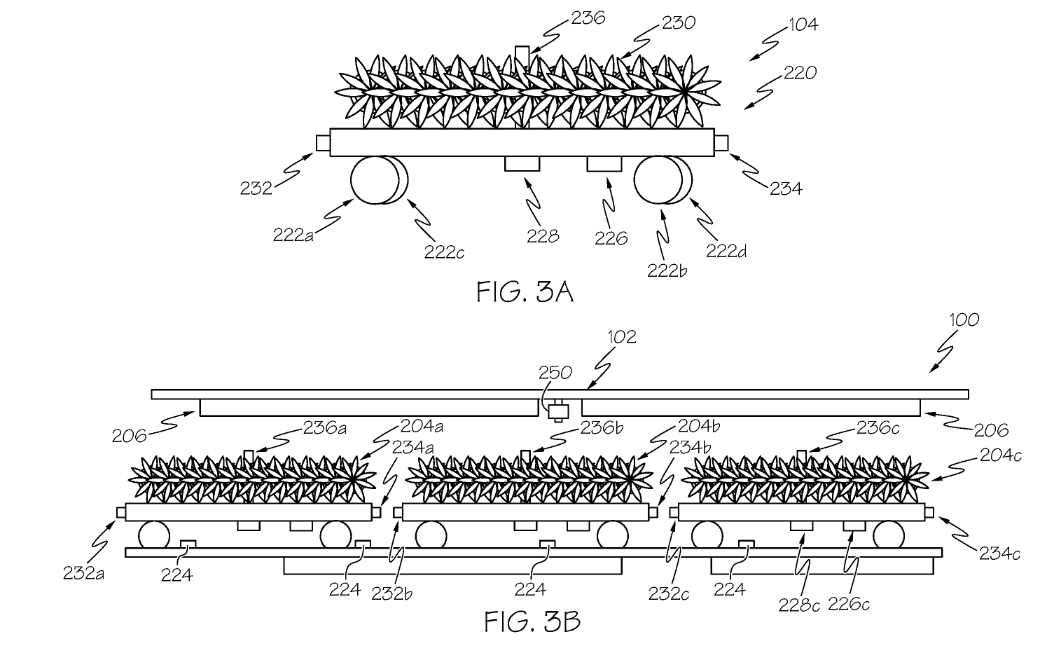

Referring now to the drawings, FIG. 1 depicts an assembly line grow pod 100 that receives a plurality of industrial carts 104, according to embodiments described herein. The assembly line grow pod 100 may be positioned on an x-y plane as shown in FIG. 1. As illustrated, the assembly line grow pod 100 may include a track 102 that holds one or more industrial carts 104. Each of the one or more industrial carts 104, as described in more detail with reference to FIGS. 3A and 3B, may include one or more wheels 222a, 222b, 222c, and 222d rotatably coupled to the industrial cart 104 and supported on the track 102, as described in more detail with reference to FIGS. 3A and 3B.

Additionally, a drive motor is coupled to the industrial cart 104. In some embodiments, the drive motor may be coupled to at least one of the one or more wheels 222a, 222b, 222c, and 222d such that the industrial cart 104 may be propelled along the track 102 in response to a signal transmitted to the drive motor. In other embodiments, the drive motor may be rotatably coupled to the track 102. For example, without limitation, the drive motor may be rotatably coupled to the track 102 through one or more gears which engage a plurality of teeth arranged along the track 102 such that the industrial cart 104 may be propelled along the track 102.

The track 102 may consist of a plurality of modular track sections. The plurality of modular track sections may include a plurality of straight modular track sections and a plurality of curved modular track sections. The track 102 may include an ascending portion 102a, a descending portion 102b, and a connection portion 102c. The ascending portion 102a and the descending portion 102b may include the plurality of curved modular track sections. The ascending portion 102a may wrap around (e.g., in a counterclockwise direction as depicted in FIG. 1) a first axis such that the industrial carts 104 ascend upward in a vertical direction. The first axis may be parallel to the z axis as shown in FIG. 1 (i.e., perpendicular to the x-y plane). The plurality of curved modular track sections of the ascending portion 102a may be tilted relative to the x-y plane (i.e., the ground) by a predetermined angle.

The descending portion 102b may be wrapped around a second axis (e.g., in a counterclockwise direction as depicted in FIG. 1) that is substantially parallel to the first axis, such that the industrial carts 104 may be returned closer to ground level. The plurality of curved modular track sections of the descending portion 102b may be tilted relative to the x-y plane (i.e., the ground) by a predetermined angle.

The connection portion 102c may include a plurality of straight modular track sections. The connection portion 102c may be relatively level with respect to the x-y plane (although this is not a requirement) and is utilized to transfer the industrial carts 104 from the ascending portion 102a to the descending portion 102b. In some embodiments, a second connection portion (not shown in FIG. 1) may be positioned near ground level that couples the descending portion 102b to the ascending portion 102a such that the industrial carts 104 may be transferred from the descending portion 102b to the ascending portion 102a. The second connection portion may include a plurality of straight modular track sections.

In some embodiments, the track 102 may include two or more parallel rails that support the industrial cart 104 via the one or more wheels 222a, 222b, 222c, and 222d rotatably coupled thereto. In some embodiments, at least two of the parallel rails of the track 102 are electrically conductive, thus capable of transmitting communication signals and/or power to and from the industrial cart 104, for example, as depicted in FIG. 3B. In yet other embodiments, a portion of the track 102 is electrically conductive and a portion of the one or more wheels 222a, 222b, 222c, and 222d are in electrical contact with the portion of the track 102 which is electrically conductive. In some embodiments, the track 102 may be segmented into more than one electrical circuit. That is, the electrically conductive portion of the track 102 may be segmented with a non-conductive section such that a first electrically conductive portion of the track 102 is electrically isolated from a second electrically conductive portion of the track 102 which is adjacent to the first electrically conductive portion of the track 102.

The communication signals and power may further be received and/or transmitted via the one or more wheels 222a, 222b, 222c, and 222d of the industrial cart 104 and to and from various components of industrial cart 104, as described in more detail herein. Various components of the industrial cart 104, as described in more detail herein, may include the drive motor, the control device, and one or more sensors.

In some embodiments, the communication signals and power signals may include an encoded address specific to an industrial cart 104 and each industrial cart 104 may include a unique address such that multiple communication signals and power may be transmitted over the same track 102 and received and/or executed by their intended recipient. For example, the assembly line grow pod 100 system may implement a digital command control system (DCC). DDC systems encode a digital packet having a command and an address of an intended recipient, for example, in the form of a pulse width modulated signal that is transmitted along with power to the track 102.

In such a system, each industrial cart 104 includes a decoder, which may be the control device coupled to the industrial cart 104, designated with a unique address. When the decoder receives a digital packet corresponding to its unique address, the decoder executes the embedded command. In some embodiments, the industrial cart 104 may also include an encoder, which may be the control device coupled to the industrial cart 104, for generating and transmitting communications signals from the industrial cart 104, thereby enabling the industrial cart 104 to communicate with other industrial carts 104 positioned along the track 102 and/or other systems or computing devices communicatively coupled with the track 102.

While the implementation of a DCC system is disclosed herein as an example of providing communication signals along with power to a designated recipient along a common interface (e.g., the track 102) any system and method capable of transmitting communication signals along with power to and from a specified recipient may be implemented. For example, in some embodiments, digital data may be transmitted over AC circuits by utilizing a zero-cross, step, and/or other communication protocol.

Additionally, while not explicitly illustrated in FIG. 1, the assembly line grow pod 100 may also include a harvesting component, a tray washing component, and other systems and components coupled to and/or in-line with the track 102. In some embodiments, the assembly line grow pod 100 may include a plurality of lighting devices, such as light emitting diodes (LEDs). The lighting devices may be disposed on the track 102 opposite the industrial carts 104 as shown in FIG. 3B, such that the lighting devices direct light waves to the industrial carts 104 on the portion the track 102 directly below. In some embodiments, the lighting devices are configured to create a plurality of different colors and/or wavelengths of light, depending on the application, the type of plant being grown, and/or other factors. Each of the plurality of lighting devices may include a unique address such that a master controller 106 may communicate with each of the plurality of lighting devices. While in some embodiments, LEDs are utilized for this purpose, this is not a requirement. Any lighting device that produces low heat and provides the desired functionality may be utilized.

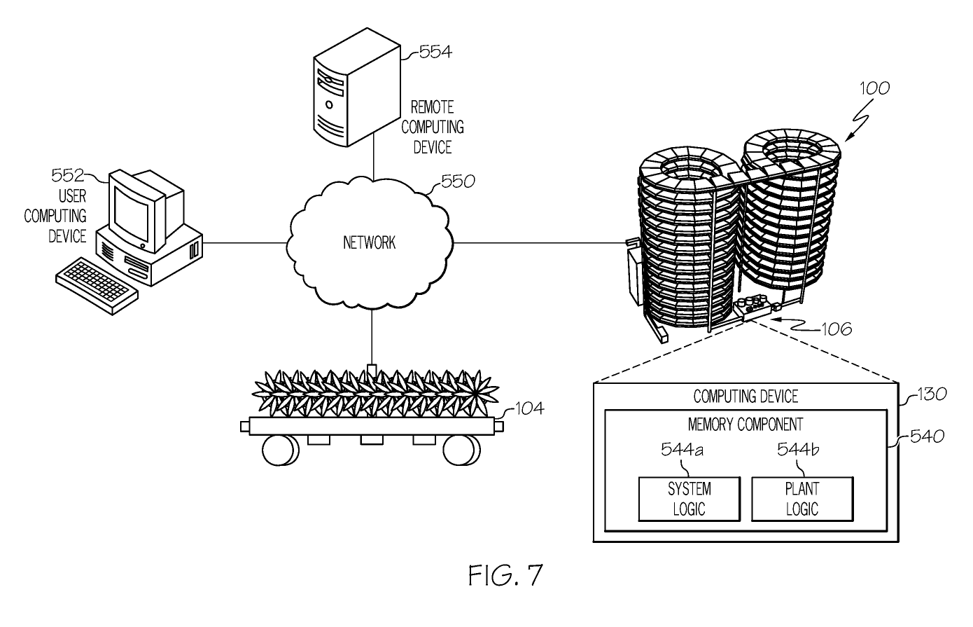

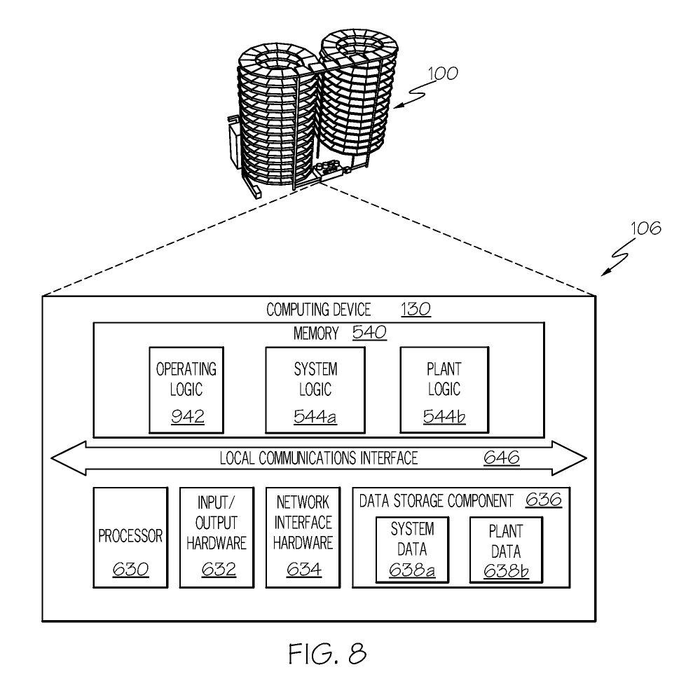

Also depicted in FIG. 1 is a master controller 106. The master controller 106 may include a computing device 130, a nutrient dosing component, a water distribution component, and/or other hardware for controlling various components of the assembly line grow pod 100. In some embodiments, the master controller 106 and/or the computing device 130 are communicatively coupled to a network 550 (as depicted and further described with reference to FIG. 7). The master controller 106 may control operations of the lighting devices, which will be described in detail below.

Coupled to the master controller 106 is a seeder component 108. The seeder component 108 may be configured to seed one or more industrial carts 104 as the industrial carts 104 pass the seeder in the assembly line. Depending on the particular embodiment, each industrial cart 104 may include a single section tray for receiving a plurality of seeds. Some embodiments may include a multiple section tray for receiving individual seeds in each section (or cell). In the embodiments with a single section tray, the seeder component 108 may detect presence of the respective industrial cart 104 and may begin laying seed across an area of the single section tray. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

In the embodiments where a multiple section tray is utilized with one or more of the industrial carts 104, the seeder component 108 may be configured to individually insert seeds into one or more of the sections of the tray. Again, the seeds may be distributed on the tray (or into individual cells) according to a desired number of seeds, a desired area the seeds should cover, a desired depth of seeds, etc. In some embodiments, the seeder component 108 may communicate the identification of the seeds being distributed to the master controller 106.

The watering component may be coupled to one or more water lines 110, which distribute water and/or nutrients to one or more trays at predetermined areas of the assembly line grow pod 100. In some embodiments, seeds may be sprayed to reduce buoyancy and then flooded. Additionally, water usage and consumption may be monitored, such that at subsequent watering stations, this data may be utilized to determine an amount of water to apply to a seed at that time.

Also depicted in FIG. 1 are airflow lines 112. Specifically, the master controller 106 may include and/or be coupled to one or more components that delivers airflow for temperature control, humidity control, pressure control, carbon dioxide control, oxygen control, nitrogen control, etc. Accordingly, the airflow lines 112 may distribute the airflow at predetermined areas in the assembly line grow pod 100.

It should be understood that while some embodiments of the track may be configured for use with a grow pod, such as that depicted in FIG. 1, this is merely an example. The track and track communications are not so limited and can be utilized for any track system where communication is desired.

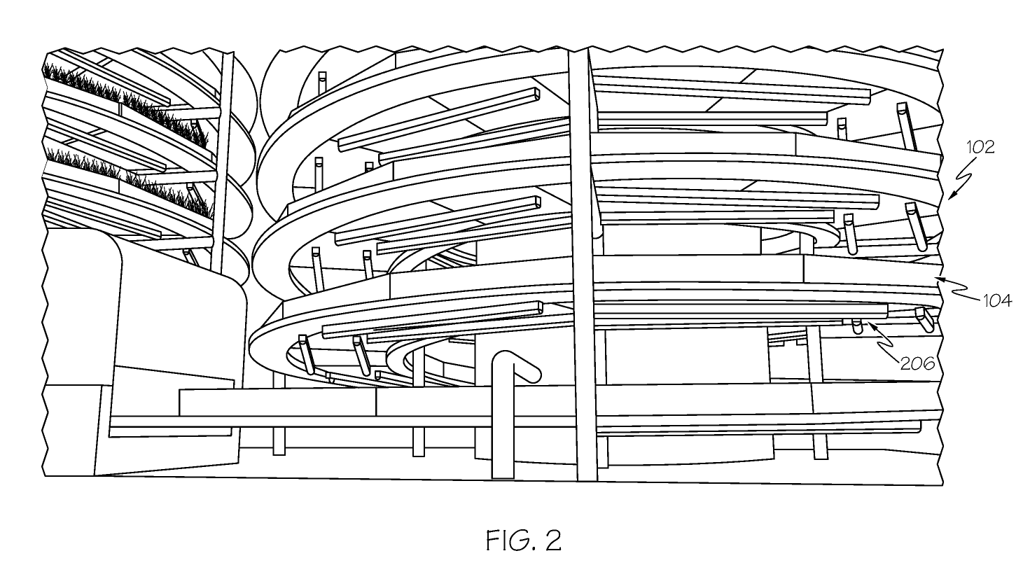

FIG. 2 depicts a portion of the assembly line grow pod 100 including a plurality of lighting devices 206, according to one or more embodiments shown and described herein. While the lighting devices 206 are illustrated as bar-shaped lighting devices in FIG. 2, the lighting devices 206 may be in any shape, for example, round-shaped lighting devices, square-shaped lighting devices, etc. In embodiments, the lighting devices 206 may be light emitting devices (LEDs). In some embodiments, the lighting devices 206 may be any other type lighting devices such as incandescent lighting devices, fluorescent lighting devices, etc.

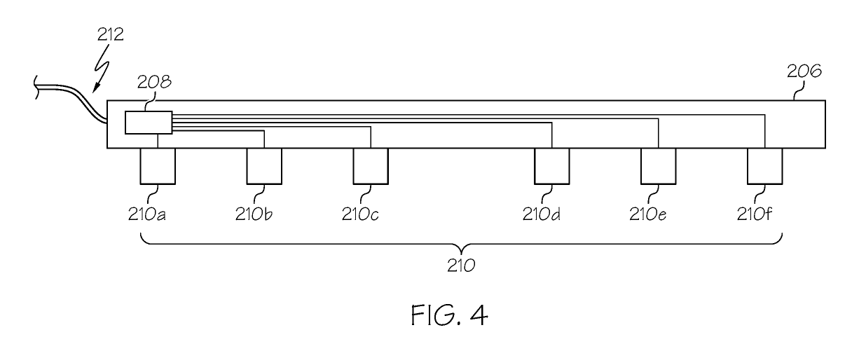

The plurality of lighting devices 206 are disposed under the track 102. For example, the plurality of lighting devices 206 are attached to the bottom surface of the track 102. The plurality of lighting devices 206 may be disposed throughout the track 102 including the ascending portion 102a, the descending portion 102b, and the connection portion 102c shown in FIG. 1. In FIG. 2, two rows of lighting devices 206 are arranged in parallel along the track 102, however, the arrangement of the lighting devices 206 is not limited thereto. For example, a single row of lighting devices 206 may be arranged along the track 102. As another example, more than two rows of lighting devices 206 may be arranged along the track 102. The lighting devices 206 are disposed along the track 102 such that the lighting devices 206 illuminate the carts 104 moving along the track 102 under the lighting devices 206. Thus, the lighting devices 206 illuminate different carts 104 as time passes. Details of the lighting devices 206 will be described below with reference to FIG. 4.

FIG. 3A depicts an industrial cart 104 that may be utilized for the assembly line grow pod 100, according to embodiments described herein. As illustrated, the industrial cart 104 includes a tray section 220 and one or more wheels 222a, 222b, 222c, and 222d. The one or more wheels 222a, 222b, 222c, and 222d may be configured to rotatably couple with the track 102, as well as receive power, from the track 102. The track 102 may additionally be configured to facilitate communication with the industrial cart 104 through the one or more wheels 222a, 222b, 222c, and 222d.

In some embodiments, one or more components may be coupled to the tray section 220. For example, a drive motor 226, a cart computing device 228, and/or a payload 230 may be coupled to the tray section 220 of the industrial cart 104. The tray section 220 may additionally include a payload 230. Depending on the particular embodiment, the payload 230 may be configured as plants (such as in an assembly line grow pod 100); however this is not a requirement, as any payload 230 may be utilized.

The drive motor 226 may be configured as an electric motor and/or any device capable of propelling the industrial cart 104 along the track 102. For example, without limitation, the drive motor 226 may be configured as a stepper motor, an alternating current (AC) or direct current (DC) brushless motor, a DC brushed motor, or the like. In some embodiments, the drive motor 226 may comprise electronic circuitry which may adjust the operation of the drive motor 226 in response to a communication signal (e.g., a command or control signal) transmitted to and received by the drive motor 226. The drive motor 226 may be coupled to the tray section 220 of the industrial cart 104 or directly coupled to the industrial cart 104.

In some embodiments, the cart computing device 228 may control the drive motor 226 in response to a leading sensor 232, a trailing sensor 234, and/or an orthogonal sensor 236 included on the industrial cart 104. Each of the leading sensor 232, the trailing sensor 234, and the orthogonal sensor 236 may comprise an infrared sensor, visual light sensor, an ultrasonic sensor, a pressure sensor, a proximity sensor, a motion sensor, a contact sensor, an image sensor, an inductive sensor (e.g., a magnetometer) or other type of sensor.

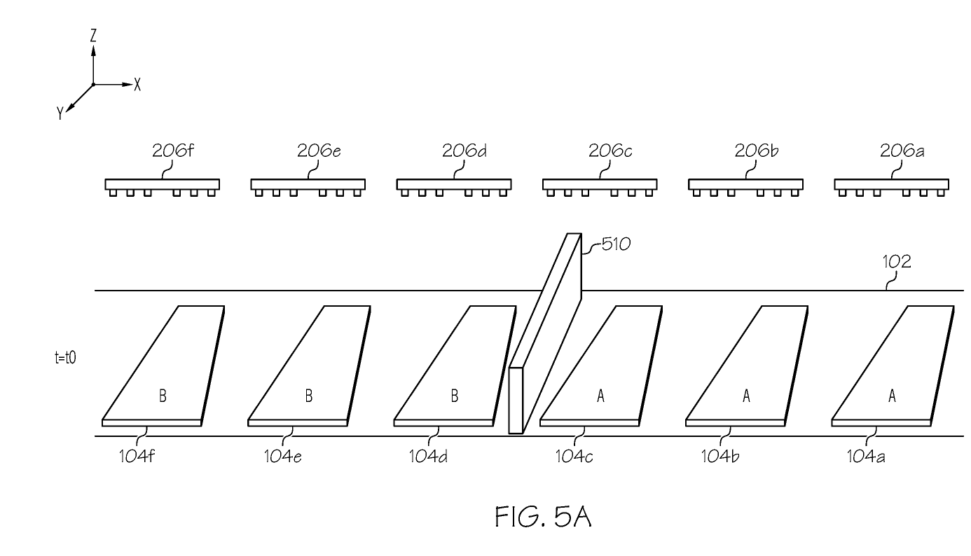

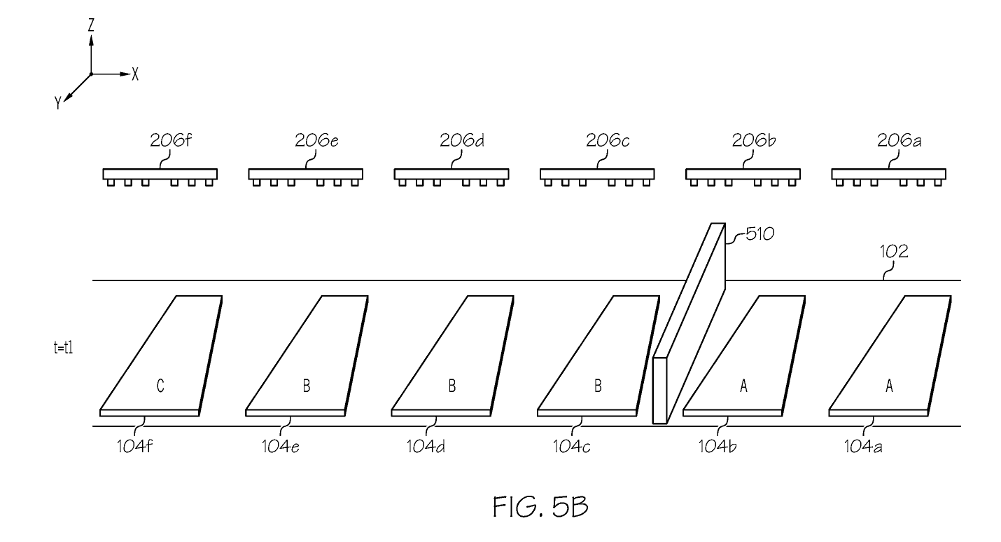

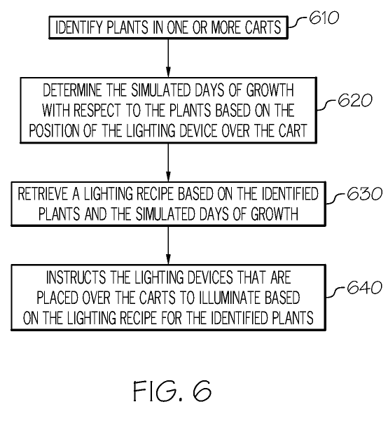

In some embodiments, the leading sensor 232, the trailing sensor 234, and the orthogonal sensor 236 may be communicatively coupled to the cart computing device 228. The cart computing device 228 may receive the one or more signals from the leading sensor 232, the trailing sensor 234, and/or the orthogonal sensor 236 and in response to the one or more signals, execute a function defined in the operating logic 642, systems logic 544a and/or plant logic 544b, which are described in more detail herein with reference to FIGS. 5 and 6. For example, in response to the one or more signals received by the cart computing device 228, the cart computing device 228 may adjust, either directly or through intermediate circuitry for example, an H-bridge or the like, the speed, direction, torque, shaft rotation angle, or the like of the drive motor 226.

In some embodiments, the leading sensor 232, the trailing sensor 234, and/or the orthogonal sensor 236 may be communicatively coupled to the master controller 106 (FIG. 1). In some embodiments, for example, the leading sensor 232, the trailing sensor 234, and the orthogonal sensor 236 may generate one or more signals that may be transmitted via the one or more wheels 222a, 222b, 222c, and 222d and the track 102 (FIG. 1). In some embodiments, the track 102 and/or the industrial cart 104 may be communicatively coupled to a network 550 (FIG. 7). Therefore, the one or more signals may be transmitted to the master controller 106 via the network 550 over network interface hardware 634 (FIG. 8) or the track 102 and in response, the master controller 106 may return a control signal to the drive motor 226 for controlling the operation of one or more drive motors 226 of one or more industrial carts 104 positioned on the track 102.

While FIG. 2A depicts the orthogonal sensor 236 positioned generally above the industrial cart 104, as previously stated, the orthogonal sensor 236 may be coupled with the industrial cart 104 in any location which allows the orthogonal sensor 236 to detect and/or communicate with objects, such as a location marker 224, above and/or below the industrial cart 104.

In some embodiments, location markers 224 may be placed along the track 102 or the supporting structures to the track 102 at pre-defined intervals. The orthogonal sensor 236, for example, without limitation, comprises a photo-eye type sensor and may be coupled to the industrial cart 104 such that the photo-eye type sensor may view the location markers 224 positioned along the track 102 below the industrial cart 104. As such, the cart computing device 228 and/or master controller 106 may receive one or more signals generated from the photo-eye in response to detecting a location marker 224 as the industrial cart travels along the track 102. The cart computing device 228 and/or master controller 106, from the one or more signals, may determine the speed of the industrial cart 104.

Additionally, the speed of each of the other industrial carts 104 traveling on the track 102 may also be determined. In some embodiments, in response to determining the speed of one or more of the industrial carts 104 on the track 102, the computing device 228 and/or master controller 106 may generate a control signal or communication signal (e.g., through the track and the wheel of the industrial cart) to the drive motor 226 of the industrial cart 104 to adjust the speed of the drive motor 226. In some embodiments, control of the drive motor 226 may be utilized to maintain a uniform speed among the one or more industrial carts 104 on the track 102 or adjust the distance between one or more of the industrial carts 104 on the track 102.

FIG. 3B depicts a plurality of industrial carts 204a, 204b, and 204c in an assembly line configuration, according to embodiments described herein. As illustrated, the industrial cart 204b is depicted as being similarly configured as the industrial cart 104 from FIG. 3A. However, in the embodiment of FIG. 3B, the industrial cart 204b is disposed on a track 102. As discussed above, at least a portion of the one or more wheels 222a, 222b, 222c, and 222d (or other portion of the industrial cart 204b) may couple with the track 102 to receive communication signals and/or power. Additionally, the portion of track 102 that is disposed above the industrial cart 204b may be coupled to a watering station 240 and/or a lighting device 242, such that the watering station 240 and/or lighting device 242 may provide light, water, nutrients, etc. to the industrial cart 204b, below.

Also depicted in FIG. 3B are a leading cart 204a and a trailing cart 204c. As the industrial carts 204a, 204b, and 204c are moving along the track 102, the leading sensor 232b and the trailing sensor 234b may detect the trailing cart 204c and the leading cart 204a, respectively, and maintain a predetermined distance from the trailing cart 204c and the leading cart 204a.

Still referring to FIG. 3B, a location marker 224 is coupled to the track 102. Although the location marker 224 is depicted as being coupled to the underside of the track 102 above the industrial carts 204a, 204b, and 204c, the location marker 224 may be positioned in any location capable of indicating a unique section of the track 102 to the industrial carts 204a, 204b, and 204c.

The location marker 224 may include a communication portal and may be configured to communicate with the any of the orthogonal sensors 236a, 236b, and 236c. The location marker 224 may comprise an infrared emitter, a bar code, a QR code or other marker capable of indicating a unique location. That is, the location marker 224 may be an active device or a passive device for indicating a location on along the track 102. In some embodiments, the location marker 224 may emit infrared light or visual light at a unique frequency that may be identifiable by the orthogonal sensors 236a, 236b, and 236c.

In some embodiments, the location marker 224 may require line of sight and thus will communicate with the one or more industrial carts 204a, 204b, and 204c that are within that range. Regardless, the respective industrial cart 204a, 204b, 204c may communicate data detected from cart sensors, including the leading sensor 232, the trailing sensor 234, and/or other sensors. Additionally, the master controller 106 may provide data and/or commands for use by the industrial carts 204a, 204b, and 204c via the location marker 224. In some embodiments, the one or more industrial carts 204a, 204b, and 204c may communicate their current location to the master controller 106 by reading the location markers 224.

In operation, for example, the location marker 224 may designate a unique location along the track 102. As the industrial cart 204b passes in proximity to the location marker 224, the orthogonal sensor 236b may register the unique location (e.g., detect the location marker 224, which is a detected event). By determining the location of the industrial cart 204b along the track 102 from the detected location marker 224 and determining the unique location which the location marker 224 represents, the position of the industrial cart 204b with respect to other industrial carts 204a, 204c may be determined and other functional attributes of the industrial cart 204b may also be determined. For example, the speed of the industrial cart 204b may be determined based on the time that elapses between two unique locations along the track 102 where the distance between the locations is known. Additionally, through communication with the master controller 106 or with the other industrial carts, distances between the industrial carts 204a, 204b, and 204c may be determined and in response the drive motors 226 may be adjusted as necessary.

Still referring to FIG. 3B, one or more imaging devices 250 may be placed at the bottom of the track 102. The one or more imaging device 250 may be placed throughout the track 102 including the ascending portion 102a, the descending portion 102b, and the connection portion 102c. The one or more imaging devices 250 may be any device having an array of sensing components (e.g., pixels) capable of detecting radiation in an ultraviolet wavelength band, a visible light wavelength band, or an infrared wavelength band. The one or more imaging devices 250 may have any resolution. The one or more imaging devices 250 are communicatively coupled to the master controller 106. For example, the one or more imaging devices 250 may be hardwired to the master controller 106 and/or may wireles sly communicate with the master controller 106. The one or more imaging devices 250 may capture an image of the payload 230 and transmit the captured image to the master controller 106. The master controller 106 may analyze the captured image to determine the status of the payload 230. For example, the master controller 106 may determine the stage of growth for the payload 230 based on the analysis of the captured image. The master controller 106 may identify the size and color of the payload 230 by analyzing the captured image and determine the stage of growth for the payload 230 based on the size and color of the payload 230.

FIG. 4 depicts one of the lighting devices 206 shown in FIGS. 2 and 3, according to embodiments described herein. As illustrated, the lighting device 206 may include circuitry to illuminate a plurality of LEDs 210a, 210b, 210c, 210d, 210e, and 210f. While FIG. 4 illustrates the lighting device 206 having six LEDs, the lighting device 206 may include less than or more than six LEDs. The LEDs 210a, 210b, 210c, 210d, 210e, and 210f are capable of illuminating several million colors. Depending on the particular embodiment, the lighting device 206 may include a processor 208, which runs commands based on information from the master controller 106. The processor 208 may be a controller, an integrated circuit, a microchip, a computer, or any other computing device. The processors 208 may communicate with the master controller 106 via a communication interface 212. In some embodiments, the processors 208 may wirelessly communicate with the master controller 106.

Accordingly, the lighting device 206 may include software and/or other logic that utilizes wave-based technology for reducing heat and other undesirable bi-products of the lighting device 206. Also depending on the particular embodiment, the LEDs 210 may be the same color or at least a portion of the LEDs 210 may be different colors to provide different photon-emitting lighting wavelengths. The color of the LEDs 210 may be controlled by the processor 208 of the lighting device 206. As an example, the LEDs 210a and 210b may output a red wavelength of light. The red wavelength may be between 610-720 nanometers. The LEDs 210c and 210d may output a blue wavelength. The blue wavelength may be between 400-470 nanometers. The LEDs 210e and 210f may output a green wavelength. Some embodiments may be configured with each of the LEDs 210 a different color, and/or with colors beyond the primary colors, such as warm white, cool white, orange, green, violet, black, etc.

Different colors of light have different impact on plants. For example, a blue wavelength of light may increase the growth rate of certain plants. A green wavelength of light may enhance chlorophyll production of certain plants and may be used as a pigment for proper plant viewing. A red wavelength of light, when combined with blue light, may yield more leaves for certain types of plants. A yellow wavelength of light may reduce plant growth for certain types of plants, compared to blue and red light. A violet wavelength of light enhances the color, taste, and aroma of plants.

It should be understood that each (or at least a portion) of the LEDs 210a, 210b, 210c, 210d, 210e, and 210f may be independent in that they may be illuminated with or without other LEDs on the lighting device 206. Additionally included is a communication interface 212, which may take the form of a power cable, an Ethernet cable, and/or other interface for providing power to the lighting device 206, as well as instructions on the lighting cycle for the lighting device 206. In some embodiments, the lighting device 206 may be hardwired for illumination as instructed by the master controller 106. Other embodiments of the lighting device 206 may be configured with hardware and/or software for receiving an instruction from the master controller 106 and controlling illumination of the LEDs.

In embodiments, the master controller 106 stores lighting recipes for various plants and instructs the lighting device 206 to illuminate based on the lighting recipes. Specifically, the lighting device 206 illuminate based on a lighting recipe for the plant in the industrial cart 104 passing under that respective lighting device 206. The recipe may include a color of light, an intensity of light, and the number of simulated days of growth associated with the plant. For example, an LED RGB recipe for a plant A and an LED RGB recipe for plant B are shown in the tables 1 and 2 below. While the total simulated days of growth are set to 6 days, it may be less than or more than 6 days.

TABLE 1
LED RGB Recipe for plant A

| Simulated Days of | | | |
|---|---|---|---|
| Growth | Red intensity | Blue intensity | Green intensity |
| Day 1 | 80% | 20% | 0% |
| Day 2 | 90% | 10% | 0% |
| Day 3 | 95% | 5% | 0% |
| Day 4 | 90% | 5% | 5% |
| Day 5 | 85% | 5% | 10% |
| Day 6 | 80% | 10% | 10% |

TABLE 2
LED RGB Recipe for plant B

| Simulated Days of | | | |
|---|---|---|---|
| Growth | Red intensity | Blue intensity | Green intensity |
| Day 1 | 80% | 15% | 5% |
| Day 2 | 85% | 10% | 5% |
| Day 3 | 83% | 7% | 10% |
| Day 4 | 80% | 10% | 10% |
| Day 5 | 80% | 15% | 5% |
| Day 6 | 90% | 10% | 0% |

In some embodiments, the simulated days of growth may be set based on various types of growth, for example, height, chlorophyll production, root growth, fruit output, foliage, etc. For example, based on the height of a plant, the simulated days of growth for the plant may be set, for example, day 1 through day 10. For each of day 1 through day 10, lighting recipes may be assigned similar to Tables 1 and 2. As another example, based on the level of chlorophyll production, the simulated days of growth for the plant may be set, for example, day 1 through day 20. For each of day 1 through day 20, lighting recipes may be assigned similar to Tables 1 and 2.

Similarly, the recipe may also include a level of warm or cool white light. The level of warm white and the level of cool white may be set between 0 and 100. The level of warm white and the level of cool white may be set depending on the number of simulated days of growth similar to Tables 1 and 2. In some embodiments, the recipe may be provided based on the stage of growth cycle (e.g., initialization, germination, growth, reproduction, etc.) instead of the simulated days of growth.

It should also be understood that by using low heat lighting elements, such as LEDs 210, the photon-emitting light may be produced with little to no heat. As a consequence, the lighting device 206 may be positioned at a place relative to a plant that maximizes optimal growth without the risk of burning the plant with heat from the lighting device 206. Additionally, cooling of a grow room that includes lighting devices 206 may be unnecessary because of the minimal amount of heat produced by the lighting devices 206. Additionally, while the lighting device 206 of FIG. 4 is depicted with six LEDs, this is also an example. Depending on the embodiment, the lighting device 206 may include as few as one low heat lighting element or as many as hundreds of low heat lighting elements to provide the desired illumination.

FIGS. 5A and 5B depict illuminating plants in carts 104 based on lighting recipes for plants, according to embodiments described herein. In embodiments, the plurality of carts 104a through 104f move along the track 102 in +x direction. Although FIGS. 5A and 5B depict the track 102 as a straight track, the track 102 may be a curved track of the ascending portion 102a or the descending portion 102b of FIG. 1.

In FIG. 5A, the carts 104a, 104b, and 104c carry crop A, and the carts 104d, 104e, and 104f carry crop B. At time t₀, the carts 104a, 104b, 104c, 104d, 104e, and 104f are positioned under lighting devices 206a, 206b, 206c, 206d, 206e, and 206f, respectively. The carts 104a through 104f move along the track 102 in +x direction. Lighting devices 206a, 206b, 206c, 206d, 206e, and 206f are fixed at positions over the carts 104a through 104f. That is, the lighting devices 206a through 206f are fixed at the positions whereas the carts 104a through 104f move in +x direction. Each of the lighting devices 206a through 206f includes a plurality of LEDs 210 as described with respect to FIG. 4 above. While FIG. 5A depicts that one lighting device 206 is positioned over a cart and illuminates that cart, more than one lighting devices may be disposed over one cart and illuminate that cart, or a single lighting device may be long enough to illuminate more than one carts at a time.

The plurality of LEDs may be communicatively coupled to the master controller 106, and controlled by the master controller 106. The colors of the plurality of LEDs 210 may be controlled based on LED recipes for the plants in carts passing under the LEDs. In embodiments, the master controller 106 may identify the plants in the carts 104a, 104b, and 104c as plant A. For example, the master controller 106 may communicate with the carts 104a, 104b, and 104c and receive information about the plants in the carts 104a, 104b, and 104c. As another example, the information about the plants in the carts 104a, 104b, and 104c may be pre-stored in the master controller 106 when the seeder component 108 seeds plant A in the carts 104a, 104b, and 104c. Specifically, each of the carts may be assigned to a unique address, and when the seeder component 108 seeds a certain plant into a cart, the unique address of the cart is associated with the information about the certain plant. The association of the unique address and the information about the certain plant may be pre-stored in the master controller 106. For example, when the cart 104c is placed under the lighting device 206c as shown in FIG. 5A, the master controller 106 may determine that plant A is in the cart 104c based on the association of the unique address for the cart 104c and the information about plant A. Similarly, the master controller 106 may identify the plants in the carts 104d, 104e, and 104f as the plant B.

The master controller 106 may determine the simulated days of growth with respect to plants on the carts 104a through 104f. In some embodiments, the master controller 106 may determine the simulated days of growth for plants on a cart based on the current position of the cart on the track 102. The track 102 may start with a seeding point and end with a harvesting point. The master controller 106 determines the progression of the cart on the track 102. For example, if the cart 104a progressed less than ⅙ of the total distance of the track 102, the master controller 106 determines that the plant in the cart 104a is in day 1 of growth given that the total day of growth is 6 days. As another example, if the cart 104a progressed more than ½ of the total distance but less than ⅔ of the total distance of the track 102, the master controller 106 determines that the plant in the cart 104a is in day 4 of growth.

In some embodiments the master controller 106 may determine the simulated days of growth for plants on a cart based on the position of the lighting device over the cart relative to the entire track 102. For example, if the lighting device 206a over the cart 104a is located before ⅙ of the entire track 102 from the seeding point, the master controller 106 determines that the plant in the cart 104a is in day 1 of growth. As another example, if the lighting device 206a is located after ½ of the total distance but before ⅔ of the total distance of the track 102, the master controller 106 determines that the plant in the cart 104a is in day 4 of growth.

In some embodiments, the lighting devices are pre-assigned to the simulated days of growth. For example, the lighting devices 206a through 206f are pre-assigned to day 1. Thus, when the carts 104a through 104f are placed under the lighting devices 206a through 206f, the master controller 106 determines that the simulated days of growth for the plants on the carts 104a through 104f is day 1.

In some embodiments, the master controller 106 may determine the simulated days of growth based on various types of growth, for example, height, chlorophyll production, root growth, fruit output, foliage. For example, the height of plants may be determined using various sensors, for example, a camera, and the master controller 106 may determine the simulated days of growth based on the height of plants. As another example, the level of chlorophyll production may be determined by capturing and processing the image of plants, and the master controller 106 may determine the simulated days of growth based on the level of chlorophyll production.

Once the day of growth and identification of plants in the carts are determined, the master controller 106 instructs the lighting devices 206a, 206b, 206c, 206d, 206e, and 206f to illuminate according to the LED recipes for the plant A and plant B. Each of the lighting devices 206a, 206b, 206c, 206d, 206e, and 206f may have a unique address. The master controller 106 controls the lighting devices 206a, 206b, 206c, 206d, 206e, and 206f using the unique address. For example, the master controller 106 determines that the cart 104a carries plant A, and the plant A is in day 3 of growth. Then, the master controller 106 may transmit a signal to the lighting device 206a that is located over the cart 104a using unique address for the lighting device 206a. The signal instructs the lighting device 206a to illuminate 95% of maximum red light intensity, and 5% of maximum blue light intensity based on the LED recipe for plant A as shown in the table 1 above. Similarly, the master controller 106 instructs the lighting devices 206b and 206c to illuminate 95% of maximum red light intensity, and 5% of maximum blue light intensity based on the LED recipe for plant A as shown in the table 1 above. For the carts 104d, 104e, and 104f, the master controller 106 determines that the carts 104d, 104e, and 104f carry plant B, and the plant B is in day 3 of growth. Then, the master controller 106 instructs the lighting device 206d, 206e, and 206f to illuminate 83% of maximum red light intensity, and 7% of maximum blue light intensity, and 10% of maximum green light intensity based on the LED recipe for plant B as shown in the table 2 above.

In some embodiments, the master controller 106 controls the lighting devices 206a through 206b based on the stage of growth of the plants carried in the carts 104a through 104f. For example, the master controller 106 may determine that the plants carried in the carts 104a through 104f are in a germination stage based on the current location of the lighting devices 206a through 206b. As another example, the master controller 106 may determine that the plants carried in the carts 104a through 104f are in a germination stage based on images captured by the one or more imaging devices 250 shown in FIG. 3B. Then, the master controller 106 may retrieve LED recipe for plant A and plant B that are in the germination stage.

FIG. 5B depicts lighting devices and carts on the track at time tl, according to embodiments described herein. The carts 104a through 104f move in +x direction. At time t1, the cart 104b is positioned under the lighting device 206a, the cart 104c is positioned under the lighting device 206b, the cart 104d is positioned under the lighting device 206c, the cart 104e is positioned under the lighting device 206d, the cart 104f is positioned under the lighting device 206e, and the cart 104g is positioned under the lighting device 206f.

In embodiments, the master controller 106 identifies that the carts 104b and 104c carry plant A and carts 104d, 104e, and 104f carry plant B. The master controller 106 identifies the plant in the cart 104g as the plant C. For example, the master controller 106 may communicate with the cart 104g and receive information about the plant in the cart 104g. As another example, the information about the plant in the carts 104g may be pre-stored in the master controller 106 when the seeder component 108 seeds plant C in the cart 104g.

The master controller 106 determines the simulated days of growth with respect to the carts 104b through 104g in a similar way as discussed above with reference to FIG. 5A. Once the simulated days of growth and identification of plants in the carts are determined, the master controller 106 instructs the lighting devices 206a, 206b, 206c, 206d, and 206e to illuminate based on the recipes for the plant A and plant B. For example, the master controller 106 determines that the carts 104b and 104c carry plant A, and the plant A is in day 3 of growth. Then, the master controller 106 instructs the lighting devices 206a and 206b to illuminate 95% of maximum red light intensity, and 5% of maximum blue light intensity based on the LED recipe for plant A as shown in the table 1 above. For the carts 104d, 104e, and 104f, the master controller 106 determines that the carts 104d, 104e, and 104f carry plant B, and the plant B is in day 3 of growth. Then, the master controller 106 instructs the lighting device 206c, 206d, and 206e to illuminate 83% of maximum red light intensity, and 7% of maximum blue light intensity, and 10% of maximum green light intensity based on the LED recipe for plant B as shown in the table 2 above. In this regard, the lighting device 206c changes its illumination from 95% of maximum red light intensity and 5% of maximum blue light intensity to 83% of maximum red light intensity, and 7% of maximum blue light intensity, and 10% of maximum green light intensity based on the recipe for plant B. The master controller 106 instructs the lighting devices 206f to illuminate based on a recipe for plant C.

In embodiments, the LED recipes for plants may be updated based on information about harvested plants. For example, if the harvested plants A are generally smaller in size than an ideal plant A, the LED recipe for plant A may be adjusted to raise the intensity of red light, and lower the intensity of other color lights. The size of plants A may be determined based on, for example, images of plants A captured by the one or more imaging devices 250 before the plants are harvested. As for another example, if the harvested plants B are not as green as an ideal plants B, the LED recipe for plant B may be adjusted to raise the intensity of green light, and lower the intensity of other color lights. The color of plants B may be determined based on, for example, images of plants B captured by the one or more imaging devices 250 before the plants are harvested.

In some embodiments, a divider 510 may be positioned over the track 102. The divider 510 may be placed at a boundary where the type of plant is changed. For example, in FIG. 5A, the divider 510 is placed between the cart 104c and the cart 104d. The divider 510 may be a plate that blocks unintended light from getting into a plant. For example, the divider 510 may block light from the lighting device 206c from getting into the plant in cart 104d. Similarly, the divider 510 may block light from lighting device 206d from getting into the plant in cart 104c. In some embodiments, the divider may be a part of each of the carts. The divider may be a wall surrounding each of the cart such that light from any one lighting device is only received by plants in the corresponding cart. For example, light from the lighting device 206a is only received by the plants in the cart 104a, light from the lighting device 206b is only received by the plants in the cart 104b, etc. Thus, each cart may be independently lighted by respective lighting devices. In other embodiments, a divider may not be placed over the track 102.

FIG. 6 depicts a flowchart for operating the lighting devices 206 based on LED recipes, according to embodiments described herein. As illustrated in block 610, the master controller 106 identifies plants in one or more carts. For example, the master controller 106 may communicate with one or more carts 104 and receive information about the plants in the carts. As another example, the information about the plants in the carts 104 may be pre-stored in the master controller 106 when the seeder component 108 seeds plants in the carts. Specifically, each of the carts may be assigned to a unique address. An operator selects the type of seeds for plants that need to be grown in the grow pod 100, for example, through a user computing device 552 shown in FIG. 7. When the seeder component 108 seeds the selected plant into a cart, the unique address of the cart is associated with the information about the certain plant. The association of the unique address and the information about the certain plant may be pre-stored in the master controller 106. Thus, the master controller 106 may identify plants in one or more carts based on the association of the unique address for the one or more cars and the information about the plant.

In block 612, the master controller 106 determines the simulated days of growth with respect to the carts under a lighting device. In some embodiments, the master controller 106 may determine the simulated days of growth for plants on a cart based on the current position of the cart on the track 102. The master controller 106 determines the current position of the cart on the track 102 that starts with a seeding point and ends at a harvesting point. For example, if a cart progressed less than ⅙ of the total distance of the track 102, the master controller 106 determines that the plant in the cart is in day 1 of growth given that the total simulated days of growth is 6 days. In some embodiments the master controller 106 may determine the simulated days of growth for plants on a cart based on the position of the lighting device over the cart. For example, if a lighting device is located before ⅙ of the entire track 102 from the seeding point, the master controller 106 determines that the plant in the cart under the lighting device is in day 1 of growth.

In block 614, the master controller 106 retrieves a lighting recipe based on the identified plants and the simulated days of growth. Lighting recipes may be pre-stored in the master controller 106. The lighting recipes may include a color of light, an intensity of light, an intensity of warm white light, an intensity of cool white light, etc.

In block 616, the master controller 106 instructs the lighting devices 206 that are placed over the carts to illuminate based on the lighting recipe for the identified plants in the carts. For example, the master controller 106 may instruct one of the lighting devices 206 to emit red light with an intensity of 90 out of 100, blue light with an intensity of 10 out of 100, warm white light with an intensity of 5 out of 100, and cool white light with an intensity of 100 out of 100.

FIG. 7 depicts a computing environment for an assembly line grow pod 100, according to embodiments described herein. As illustrated, the assembly line grow pod 100 may include a master controller 106, which may include a computing device 130. The computing device 130 may include a memory component 540, which stores systems logic 544a and plant logic 544b. As described in more detail below, the systems logic 544a may monitor and control operations of one or more of the components of the assembly line grow pod 100. The plant logic 544b may be configured to determine and/or receive a recipe for plant growth and may facilitate implementation of the recipe via the systems logic 544a.

Additionally, the assembly line grow pod 100 is coupled to a network 550. The network 550 may include the internet or other wide area network, a local network, such as a local area network, a near field network, such as Bluetooth or a near field communication (NFC) network. The network 550 is also coupled to a user computing device 552 and/or a remote computing device 554. The user computing device 552 may include a personal computer, laptop, mobile device, tablet, server, etc. and may be utilized as an interface with a user. As an example, a user may send a recipe to the computing device 130 for implementation by the assembly line grow pod 100. Another example may include the assembly line grow pod 100 sending notifications to a user of the user computing device 552.

Similarly, the remote computing device 554 may include a server, personal computer, tablet, mobile device, etc. and may be utilized for machine to machine communications. As an example, if the assembly line grow pod 100 determines a type of seed being used (and/or other information, such as ambient conditions), the computing device 130 may communicate with the remote computing device 554 to retrieve a previously stored recipe for those conditions. As such, some embodiments may utilize an application program interface (API) to facilitate this or other computer-to-computer communications.

FIG. 8 depicts a master controller 106 for an assembly line grow pod 100, according to embodiments described herein. As illustrated, the master controller 106 includes a processor 630, input/output hardware 632, the network interface hardware 634, a data storage component 636 (which stores systems data 638a, plant data 638b, and/or other data), and the memory component 540. The memory component 540 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the master controller 106 and/or external to the master controller 106.

The memory component 540 may store operating logic 642, the systems logic 544a, and the plant logic 544b. The systems logic 544a and the plant logic 544b may each include a plurality of different pieces of logic, each of which may be embodied as a computer program, firmware, and/or hardware, as an example. A local communications interface 646 is also included in FIG. 8 and may be implemented as a bus or other communication interface to facilitate communication among the components of the master controller 106.

The processor 630 may include any processing component operable to receive and execute instructions (such as from a data storage component 636 and/or the memory component 540). The input/output hardware 632 may include and/or be configured to interface with microphones, speakers, a display, and/or other hardware.

The network interface hardware 634 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the master controller 106 and other computing devices, such as the user computing device 552 and/or remote computing device 554.

The operating logic 642 may include an operating system and/or other software for managing components of the master controller 106. As also discussed above, systems logic 544a and the plant logic 544b may reside in the memory component 540 and may be configured to performer the functionality, as described herein.

It should be understood that while the components in FIG. 8 are illustrated as residing within the master controller 106, this is merely an example. In some embodiments, one or more of the components may reside external to the master controller 106. It should also be understood that, while the master controller 106 is illustrated as a single device, this is also merely an example. In some embodiments, the systems logic 544a and the plant logic 544b may reside on different computing devices. As an example, one or more of the functionalities and/or components described herein may be provided by the user computing device 552 and/or remote computing device 554.

Additionally, while the master controller 106 is illustrated with the systems logic 544a and the plant logic 544b as separate logical components, this is also an example. In some embodiments, a single piece of logic (and/or or several linked modules) may cause the master controller 106 to provide the described functionality.

As illustrated above, various embodiments for utilizing lighting recipes for an assembly line grow pod are disclosed. These embodiments create a quick growing, small footprint, chemical free, low labor solution to growing microgreens and other plants for harvesting. These embodiments may create recipes and/or receive recipes that dictate the timing and wavelength of light, pressure, temperature, watering, nutrients, molecular atmosphere, and/or other variables the optimize plant growth and output. The recipe may be implemented strictly and/or modified based on results of a particular plant, tray, or crop.

Accordingly, some embodiments may include a light control system that includes one or more lighting devices, one or more carts configured to move along a track under the one or more lighting devices, and a controller. The controller includes one or more processors, one or more memory modules storing lighting recipes, and machine readable instructions stored in the one or more memory modules that, when executed by the one or more processors, cause the controller to: identify a plant in the one or more carts, retrieve a lighting recipe for the identified plant from the one or more memory modules, and control operations of the one or more lighting devices based on the lighting recipe for the identified plant.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for utilizing LED recipes for an assembly line grow pod. It should also be understood that these embodiments are merely exemplary and are not intended to limit the scope of this disclosure.

What is claimed is:

1. A light control system comprising:
one or more lighting devices;
one or more carts configured to move along a track under the one or more lighting devices; and
a controller comprising:
one or more processors;
one or more memory modules storing lighting recipes; and
machine readable instructions stored in the one or more memory modules that, when executed by the one or more processors, cause the controller to:
identify a plant in the one or more carts;
retrieve a lighting recipe for the identified plant from the one or more memory modules; and
control operations of the one or more lighting devices based on the lighting recipe for the identified plant.

2. The light control system of claim 1, wherein the machine readable instructions stored in the one or more memory modules, when executed by the one or more processors, cause the controller to:
determine a number of days of simulated growth of the plant; and
retrieve the lighting recipe for the identified plant from the one or more memory modules based on the number of days of simulated growth of the plant.

3. The light control system of claim 2, wherein the track includes a seeding point, and
the machine readable instructions stored in the one or more memory modules, when executed by the one or more processors, cause the controller to determine a number of days of simulated growth of the plant based on a location of a cart carrying the plant on the track.

4. The light control system of claim 2, wherein the machine readable instructions stored in the one or more memory modules, when executed by the one or more processors, cause the controller to determine a number of days of simulated growth of the plant based on a height or a chlorophyll production level of the plant carried in a cart.

5. The light control system of claim 1, wherein the one or more lighting devices include one or more LED devices.

6. The light control system of claim 5, wherein the machine readable instructions stored in the one or more memory modules, when executed by the one or more processors, cause the controller to control at least one of the following: a red intensity, a blue intensity or a green intensity of the one or more LED devices based on the lighting recipe for the identified plant.

7. The light control system of claim 5, wherein the machine readable instructions stored in the one or more memory modules, when executed by the one or more processors, cause the controller to control at least one of the following: a cool white intensity or a warm white intensity of the one or more LED devices based on the lighting recipe for the identified plant.

8. The light control system of claim 1, wherein the track includes an ascending portion wrapping around a first axis perpendicular to ground and a descending portion wrapping around a second axis perpendicular to the ground, and the one or more lighting devices are disposed at a bottom side of the track, such that the one or more lighting devices illuminate the plant on a portion of track below.

9. The light control system of claim 1, further comprising:
a camera configured to capture an image of the plant in one or more carts and transmit the captured image to the controller.

10. The light control system of claim 9, wherein the machine readable instructions stored in the one or more memory modules, when executed by the one or more processors, cause the controller to update the lighting recipe based on the captured image of the plant.

11. A method for controlling light for plants, the method comprising:
sending, by a grow pod computing device, instructions to one or more carts to move along a track under one or more lighting devices;
identifying, by the grow pod computing device, a plant in the one or more carts;
retrieving, by the grow pod computing device, a lighting recipe for the identified plant from one or more memory modules; and
controlling, by the grow pod computing device, operations of the one or more lighting devices based on the lighting recipe for the identified plant.

12. The method of claim 11, further comprising:
determining a number of days of simulated growth of the plant; and
retrieving the lighting recipe for the identified plant from the one or more memory modules based on the number of days of simulated growth of the plant.

13. The method of claim 12, wherein determining the number of days of simulated growth of the plant comprises determining the number of days of simulated growth of the plant based on a location of a cart carrying the plant on the track.

14. The method of claim 11, wherein controlling operations of the one or more lighting devices comprises controlling at least one of the following: a red intensity, a blue intensity or a green intensity of the one or more lighting devices based on the lighting recipe for the identified plant.

15. The method of claim 11, wherein controlling operations of the one or more lighting devices comprises controlling at least one of the following: a cool white intensity or a warm white intensity of the one or more lighting devices based on the lighting recipe for the identified plant.

16. A controller for one or more lighting devices, comprising
one or more processors;
one or more memory modules storing lighting recipes; and
machine readable instructions stored in the one or more memory modules that, when executed by the one or more processors, cause the controller to:
send instructions to one or more carts to move along a track under the one or more lighting devices;
identify a plant in the one or more carts positioned under the one or more lighting devices;
retrieve a lighting recipe for the identified plant from the one or more memory modules; and
send one or more instructions for controlling operations of the one or more lighting devices based on the lighting recipe for the identified plant.

17. The controller of claim 16, wherein the machine readable instructions stored in the one or more memory modules, when executed by the one or more processors, cause the controller to:
determine a number of days of simulated growth of the plant; and
retrieve the lighting recipe for the identified plant from the one or more memory modules based on the number of days of simulated growth of the plant.

18. The controller of claim 17, wherein the machine readable instructions stored in the one or more memory modules, when executed by the one or more processors, cause the controller to determine the number of days of simulated growth of the plant based on a location of a cart carrying the plant.

19. The controller of claim 16, wherein the one or more instructions for controlling operation of the one or more lighting devices include instructions for controlling a red intensity, a blue intensity or a green intensity of the one or more lighting devices based on the lighting recipe for the identified plant.

20. The controller of claim 16, wherein the one or more instructions for controlling operation of the one or more lighting devices include instructions for controlling a cool white intensity or a warm white intensity of the one or more lighting devices based on the lighting recipe for the identified plant.
